(19) United States
(12) Patent Application Publication
(10) Pub. No.: US 2005/0031742 A1
(43) Pub. Date: Feb. 10, 2005

(54) Method for enhancing organoleptic properties of protein for inclusion in consumer food products and products produced thereby

(76) Inventor: Kyle A. Newkirk, Greenbelt, MD (US)

Correspondence Address: GENERAL MILLS, INC., P.O. BOX 1113, MINNEAPOLIS, MN, 55440, US

(21) Appl. No.: 10/636,000

(22) Filed: Aug. 7, 2003

(51) Int. Cl. A23L 1/31

(52) U.S. Cl. 426/281

(57) ABSTRACT

The present invention relates a method for improving the organoleptic properties of protein used in the production of frozen and retort consumer food applications. More specifically, the present invention is directed to the addition of a liquid fat during the step of marinating the protein to enhance the flavor and texture of the meat products.

### CROSS-REFERENCES TO RELATED APPLICATIONS

None.

### FIELD OF THE INVENTION

The present invention relates a method for improving the organoleptic properties of protein used in the production of frozen, canned and retort consumer food applications. More specifically, the present invention is directed to the addition of a liquid fat during the step of marinating the protein to enhance the flavor and texture of the meat products and improve moisture retention.

### BACKGROUND OF THE INVENTION

There are a number of thermally treated and other processed meat products that are incorporated into soups, canned meals, frozen dinners and entrees, refrigerated and frozen snacks (pizzas, burritos, tacos to name a few) and the like. The difficulty with such processed meat products is that the meat can often lose many of its desired attributes such as color, texture, taste and even suffer from a substantial reduction in size or loss in yield during the processing. Consumers that meet with such disappointing meat products may choose another product or may not repurchase the product after the initial purchase has been made.

The meat portion of the products described above, are typically the most costly portion of the commercial offering that is, meat is more expensive than other components which may be included with consumer product such as vegetables, pasta, sauces and the like. Due to what is considered as normal processing of the meat products, as size or weight is lost, the producer if faced with the undesirable circumstance of having to either increase the amount of the meat starting material to make up for the loss in volume, or subject the meat to enhancement steps which may discolor the meat or decrease the flavor and/or texture of the meat product. As such, even a small improvement in the yield of meat which can be produced through thermal processing will generate a substantial savings to the producer as well as create improved benefits for the consumer.

A number of prior art solutions have been proposed to redress this situation. One such approach consists of coating the meat with a “skin” in order to prevent the moisture and flavors from escaping. An example of this technique is described in U.S. Pat. No. 3,792,173, which provides for a process of coating the exterior of the meat with a powder, consisting of a mixture of sugary syrup and a partially gelatinized starch, having a gelatinization temperature of not lower than 150°. The powder is defined as being particularly useful with sausages, hamburger, frankfurters and meat loaves. However, such processes can leave a product with an additional sheen or shiny appearance which may not be particularly desirable as the product may appear to have been treated. Such coatings are also not typically acceptable under high heat and pressure applications.

Another example of a coating for a meat product with a powder is found in U.S. Pat. No. 5,384,140. This patent describes a dry powdery coating that consists of a starch, a protein and optional flavoring is applied to the meat. The coating forms a skin, which limits the penetration depth of microwave energy so as to prevent the meat product from becoming prematurely dry. However, this system relies on a “water gain” step to compensate for the water that is lost during the microwave cooking, thereby arbitrarily adding weight to the product as well as suffering from the drawbacks identified above. In addition, the use of an additional protein in the marinade system arbitrarily increases the cost associated with producing the meat product.

U.S. Pat. No. 5,403,600 provides another coating system used in retaining moisture in meat products. The coating provided in this solution includes a mixture of egg albumen, milk protein, an ungelatinized starch and water. However, the starch in this application acts to provide increase elasticity to the albumen and milk protein thereby decreasing the need for the starch to serve as a vehicle to take up water. In addition, the solution proposed in U.S. Pat. No. 5,403,600 provides for a significantly high usage of starch, one that is above 25% by weight of the mixture, and more preferably 35 to 55% of the weight of the mixture, in which the meat is coated.

Another problem associated with thermally processed meat is shrinkage, in that the meat, which has a tendency to lose moisture during processing, will also shrink in size making it appear that the manufacturer is trying to reduce cost by reducing the amount of meat in the portion, when this in fact is not the case. Rather, the manufacturer may be adding more meat to the process to make up for meat product that is lost during the treatment step or steps.

A still further problem encountered during retorting and other thermal processing of meat or protein intended for inclusion in a consumer food product is that the flavor and texture of the protein source can change during thermal treatment creating a less than expected savory experience for the consumer.

What is need therefore is a method by which the protein or meat source for a consumer food product can be enhanced during a thermal treatment process so as to deliver the intended organoleptic experience for a consumer without significantly increasing the cost associated with such treatment step.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention represents approximately a typically 7-9% improvement over thermally processed meats that use a traditional or conventional marinade system and a 15-20% increase over thermally processed meats that use no marinade system in the preparation of the meat products. That is, the improvement comprises stabilizing the ultimate yield of meat products subjected to thermal treatment steps such as with a canning or retorting operation. By using the novel combination set forth below, the multiple cooking steps of a thermal processing operation do not denigrate the meat products and instead allows the meat to be infused with additional moisture and even flavors to minimize yield loss.

In one embodiment of the present invention a method for producing thermally processed meat products for canning or retort operations that provides improved moisture content and texture after retorting is described and includes the steps of initially providing a meat source and creating a first mixture in a chamber. The mixture includes at least water, a phosphate, a salt and at least a first starch and a fat source. The meat source is added to the first mixture in said chamber and a vacuum is pulled. Next, the meat source infused with the first mixture to create a marinated meat. The marinated meat is discharged from the container and then cooked. After cooking, the meat is placed in a container in a vessel along with a second mixture and is cooked in the container. Alternatively, or in addition, the meat after discharging may be diced and then frozen prior to being placed in the container.

In a further embodiment of the present invention, a marinade solution for use with thermally treating meat products to stabilize yield in a canning or retorting operation is described and includes first and second starches. The first and second starches making up less than 25% by weight of the marinade solution. The marinade solution also includes a phosphate selected from potassium phosphate, sodium phosphate and mixtures thereof. The marinade solution has a salt that is selected from sodium chloride, potassium chloride and mixtures thereof, a fat source provide in an amount ranging from about 1 to about 3 percent by weight of the marinade and water. The solution is infused into a meat source to stabilize processing yield of the meat source through thermal processing.

The foregoing and other objects of the invention will become clear from an inspection of the detailed description of the invention and from the claims appended hereto.

### DETAILED DESCRIPTION OF THE INVENTION

The present invention is now illustrated in greater detail by way of the following detailed description, but it should be understood that the present invention is not to be construed as being limited thereto.

Surprisingly, it has been found that through the use of a source of liquid fat which is added during the treatment phase, thermally processed meat products, such as those found in frozen, canned or retorted operations, such as with soups, stews, dinner entrees and the like, can have increased tenderness and improved size without loss of desirable attributes such as color, flavor, texture or appearance. In addition, the volume of the protein or meat source has been found to actually increase through the thermal treatment process as the protein or meat source retains as much as an additional ten percent moisture during the tumbling and marinating steps described below.

In addition to adding a source of liquid fat to the retort or thermal processing application, the invention may include the use of additional starches having differing gelatinization points. For example, one of the starches in the present marinade system requires higher processing temperatures in order to gelatinize, generally temperatures about 200° F. or greater and preferably greater than 200° F. As such, the starches selected for use in the marinade system of the present invention function to improve water-holding capacity of the meat during the multiple processing or cooking steps associated with canning or retorting. This enables the meat to hold on to meat juices and moisture thereby reducing shrinkage and loss of flavor and texture. That is, the starch based marinade provides gelling properties such that during and after thermal processing, the starches provide enhanced water binding ability thereby improving the textural properties over a conventional marinade system.

The present invention is now illustrated in greater detail by way of the following examples, but it should be understood that the present invention is not to be construed as being limited thereto.

In carrying out the present invention, a comparison test was conducted between meat subjected to a conventional process and meat prepared in accordance with the invention. The control (and listed as control in the tables below) consisted of the following:

| Ingredient | Percentage | Weight |
|---|---|---|
| Chicken | 80% | 3995.2/gm |
| Water | 17.30% | 863.96/gm |
| Salt | 1% | 49.94/gm |
| M160 | 1.3% | 64.92/gm |
| Phosphate | 0.4% | 19.98/gm |
| Total | 100% | |

The meat prepared in accordance with the present example (and listed as Test A and Test B in tables 2 and 3 below) consisted of the following:

| Ingredient | Percentage | Weight |
|---|---|---|
| Chicken | 80% | 3995.2/gm |
| Water | 14.2% | 809.02/gm |
| Fat Source | 2% | 100/gm |
| Salt | 1.5% | 74.91/gm |
| ISP | 0.75% | 37.46/gm |
| Dent Corn Starch | 0.4% | 19.98/gm |
| High Amylose | 0.75% | 37.46/gm |
| Corn Starch | | |
| Phosphate | 0.4% | 19.98/gm |
| Total | 100% | |

Each of the ingredients for the control and the exemplary formulation were initially measured out. The phosphate was then mixed with the water until it was dissolved, then the remaining ingredients were added to the water and the solution mixed. In the above example, the mixture will be referred to as the marinade.

A dent corn starch, such as Melojel is a amylose containing food grade starch, derived from corn (approximately 25% amylose) and is available from National Starch of Bridgewater, N.J. A high amylose corn starch, such as Hylon V, is a food grade starch (approximately 50% or more amylose) and is derived from corn and is available from National Starch of Bridgewater, N.J. Other starches such as potato, rice, tapioca and combinations thereof may be used. The combination of starches makes up less than 25% by weight of the first mixture or marinade that is introduced into chamber and preferably less than 10% by weight and more preferably less than 5% by weight of the mixture. The high amylose starch is selected for properties, including gelatinization temperatures of greater than 200° F. and more preferably greater than 250° F. and even 300° F. The first starch is selected for its gelatinization temperatures below 175° F., preferably below 165° F. and possibly as low as 140° F. By providing a combination of starches the lower starches gelatinize during a first cooking or thermal treatment step and the second starch (high amylose) gelatinizes during a second thermal treatment step.

The phosphate as used herein is preferably sodium tripolyphosphate available from a number of known commercial sources. Another phosphates that may also be useable is potassium tripolyphosphate which may be used alone or in combination with sodium tripolyphosphate. The salts used herein may be sodium chloride, potassium chloride or mixtures thereof.

ISP is isolated soy protein available from Protein Technologies, International, a division of E. I. Du Pont de Nemours Company, Wilmington, Del. M160 is a blend of modified food starch, soy protein isolate, carrageen (seaweed) also available from Protein Technologies, International, a division of E. I. Du Pont de Nemours Company, Wilmington, Del. While isolated soy protein has been used in the foregoing example, other protein sources are of course available and useable in connection with the present invention. These include but are not limited to soy protein, whey protein, wheat protein, rice protein, corn protein, oat protein and the like or mixtures thereof.

The fat source identified above may be selected from any animal, grain or vegetable based source including chicken fat, soybean oil, palm oil, coconut oil, sunflower oil, corn oil, combinations thereof and the like. Preferably, the fat source is provided in an amount ranging from about 1 to about 3 percent by weight of the solution or marinade and preferably in an amount of about 2 percent.

The chicken is then placed in a tumbler and the marinade added. A vacuum is pulled to a minimum of 22 to about 30 inches with about 25 to 30 inches being preferred. The chicken/marinade combination is then tumbled for approximately 30 minutes. The chicken in the control is also placed in a tumbler with its solution; a vacuum is pulled and then tumbled for 30 minutes. A second batch prepared in connection with the present invention was tumbled for 45 minutes. After the tumbling periods were complete, the contents of the vessel were emptied and placed in a cooler. The tumbling or marinating time period can range from about 15 minutes to around an hour. Tumbling the marinade and meat under a vacuum, causes the meat/starch complex to act as a sponge thereby permitting the meat to become infused with the marinade.

After tumbling, a portion of the meat that has been infused with the marinade or other solution was weighed and the results that were obtained are set forth in the following table.

TABLE 1

| | % Yield = |
|---|---|
| Tumbling Results | Weight After Tumbling/before tumbling |
| Control (30 minutes) | 117% = 4686.3 grams/3994.3 grams |
| Test A (30 minutes) | 119% = 4779.7 grams/4005.3 grams |
| Test B (30 minutes) | 119% = 4788.5 grams/3996.1 grams |

The remaining portions of the sample that were prepared in connection with the control and in accordance with the present invention were pulled from the tumbler and then placed in a convection oven with humidity control. (Humidity control may include a pan of water placed in the oven to provide additional humidity during the cooking process.) The cooking process may use a rotating, mesh belt that permits the heating to occur on both sides of the meat as it is traveling through the oven.

During the cooking the internal temperature of the chicken is monitored so as to not exceed 175° F. The meat is removed or discharged from the oven and allowed to cool to room temperature. The chicken is then diced into roughly ¾″ squares and then frozen. During this first cooking step, the first starch gelatinizes and the second starch remains in the marinade matrix.

Cooking of the meat source after the step of infusing the meat may be an optional step, as the applicants have found that the present invention can achieve similar results without this intermediate cooking step. If no intermediate cooking occurs, the meat, may be diced or cut into appropriate sizes and then placed frozen into the second mixture within the containers in the vessel. The first starch will gelatinize at a temperature below 175° F. and the second starch when the temperature exceeds 200° F.

Next, the meat dices are placed into containers with a broth and then are placed within a retort and cooked again for a period of time ranging from 10 minutes to an hour. The containers are filled with a second mixture and in this example, chicken broth is selected and meat and second mixture subjected to retorting. During this thermal treatment step, the temperatures typically exceed 200° F. and are sufficient to gelatinize the second starch.

The second mixture that is used in the present invention may be broth, soup or meat stock, sauces or other flavor imparting fluids that can provide desirable flavors or textures to the meat being treated or be part of the consumer product.

In comparing the results with that of the test material prepared in accordance with the present invention during cooking with a control, the results presented in the following table were obtained.

TABLE 2

| | % Processing Yield = final weight/total weight |
|---|---|
| Control | 87.9% = 1110.3 grams/1262 grams |
| Test A | 96.7% = 1215 grams/1255.5 grams |
| Test B | 95.4% = 1170.6 grams/1227.6 grams |

As can be seen from the results presented in table 2, a 7-9% increase over the control was obtained by using the system described herein thereby improving the yield of the meat subjected to the marinade. While not wishing to be bound to any particular theory the yield improvement is believed due to enhanced moisture retention of the protein or meat source and as such the protein or meat source has a more tender, juicy texture than those prepared in a marinade without the additional fat and or starch sources described herein.

The “green yield” of the control and test materials is provided in the following table. In order to obtain the “chicken weight” in table 3, the “total weight” in the processing yield calculation is multiplied by the amount of chicken/meat in the original make up or ingredient listing. For example, in the control, the total weight in the processing yield calculation was 1262 grams multiplied by 80% (the proportion of the chicken/meat in the ingredients) yields the chicken weight or 1262 grams×0.80=1009.6 grams. The term “green yield” refers to the yield of the entire product or batch being produced by the process. In order to calculate green yield, the weight of the meat and ingredients used in the process added together. After cooking, the weight and ingredients are weighed and the amount or weight is the resulting green yield. The present invention stabilizes the yield of the meat and minimizes loss of the meat during processing.

TABLE 3

| | % Green Yield = final weight/chicken weight |
|---|---|
| Control | 109% = 1110.3 grams/1009.6 grams |
| Test A | 120% = 1215 grams/1004.4 grams |
| Test B | 119% = 1170.6 grams/982.1 grams |

Table 3 also provides the results of improved or increased green yield that occurred through the treatment of a meat product using a high amylose starch marinade system of the present invention.

The foregoing tables provide that by treating the meat with the starch marinade matrix as provided in the present invention, significant yield improvements can be obtained resulting in a thermally processed meat product having enhanced flavor and texture without a loss in size of the meat product during subsequent thermal processing, such as canning or retorting. Treatment of meat products in accordance with the present invention consistently showed an improvement (ranging from 5 to 9% over conventional marinade systems) in the amount or weight of chicken that was left over after processing.

While the examples set forth in the instant application include chicken, the invention as described herein is also suitable for use with beef, lamb, pork, bison, alligator, fish, shell fish, mollusks and mixtures thereof.

Other starches may be suitable for use with the present invention, such starches include but are not limited to potato, tapioca, rice, wheat and combinations thereof. In addition, the present invention may use chemically modified or unmodified (natural) starches, with unmodified starches being preferred.

It will thus be seen according to the present invention a highly advantageous marinade system has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method for producing thermally processed meat products for thermal processing operations having improved moisture content, flavor and texture, comprising the steps of;
providing a meat source;
creating a first mixture in a chamber including at least water, a phosphate, a salt and at least a first starch and a liquid fat source ranging from about 1 to about 3 percent of the marinade;
adding said meat source to said first mixture in said chamber;
pulling a vacuum in said chamber;
infusing said meat source with said first mixture to create a marinated meat;
discharging said marinated meat; and
cooking said marinated meat in said container.

2. A method for producing thermally processed meat products as recited in claim 1, wherein a second starch is provided and said first and second starches have different gelatinization points.

3. A method for producing thermally processed meat products as recited in claim 1, wherein the phosphate includes sodium tripolyphosphate, sodium phosphates or combinations thereof.

4. A method for producing thermally processed meat products as recited in claim 1, wherein the mixture includes a protein source.

5. A method for producing thermally processed meat products as recited in claim 4, wherein the protein source is selected from soy protein, isolated soy protein, whey protein, wheat protein, rice protein, corn protein, oat protein or mixtures thereof.

6. A method for producing thermally processed meat products as recited in claim 1, wherein the meat source is selected from chicken, beef, pork, lamb, bison, alligator, fish, shell fish, mollusks and mixtures thereof.

7. A method for producing thermally processed meat products as recited in claim 1, wherein the vacuum is pulled to a minimum of 22 inches.

8. A method for producing thermally processed meat products as recited in claim 1, wherein a second mixture is added and is selected from broth, soup, sauces, flavoring fluids and combinations thereof.

9. A method for producing thermally processed meat products as recited in claim 1, wherein the thermal processing operations are canning and retorting.

10. A method for producing thermally processed meat products as recited in claim 1, wherein the coating is done by tumbling.

11. A method for producing thermally processed meat products as recited in claim 1, comprising the further step of after infusing the meat source, cooking the marinated meat.

12. A method for producing thermally processed meat products as recited in claim 1, including a further step of after discharging the marinated meat, cutting the marinated meat and then freezing the cut marinated meat.

13. A method for producing thermally processed meat products as recited in claim 1, wherein the liquid fat source is selected from a group including chicken fat, soybean oil, palm oil, coconut oil, sunflower oil, corn oil and combinations thereof.

14. A marinade solution for use with thermally treating meat products to stabilize yield in a canning or retorting operation comprising;
first and second starches, said first and second starches making up less than 25% by weight of the marinade solution;
a phosphate selected from potassium phosphate, sodium phosphate and mixtures thereof;
a salt selected from sodium chloride, potassium chloride and mixtures thereof;
a fat source provide in an amount ranging from about 1 to about 3 percent by weight of the marinade;
water; and
wherein said solution is infused into a meat source to stabilize processing yield of said meat source through thermal processing.

15. A marinade solution for use with thermally treating meat products to stabilize yield in a canning or retorting operation as recited in claim 14, wherein said marinade solution includes a protein source selected from soy protein, isolated soy protein, whey protein, wheat protein, rice protein, corn protein, oat protein or mixtures thereof.

16. A marinade solution for use with thermally treating meat products to stabilize yield in a canning or retorting operation as recited in claim 14, wherein said meat source is selected from chicken, beef, pork, lamb, bison, alligator, fish, shell fish, mollusks and mixtures thereof.

17. A marinade solution for use with thermally treating meat products to stabilize yield in a canning or retorting operation as recited in claim 14, wherein said first starch has a gellatinization temperature of less than 175° F. and said second starch has a gellatinization temperature of about 200° F. or greater.

18. A marinade solution for use with thermally treating meat products to stabilize yield in a canning or retorting operation as recited in claim 14, wherein said processing yield results in an improvement of between 7 and 9%.

19. A marinade solution for use with thermally treating meat products to stabilize yield in a canning or retorting operation as recited in claim 14, wherein said solution is infused under elevated heat and pressure.

20. A marinade solution for use with thermally treating meat products to stabilize yield in a canning or retorting operation as recited in claim 14, wherein the meat source under elevated heat does not exceed an internal temperature of more than 165° F.

21. A meat product of the method of claim 1.

22. A meat product as recited in claim 21, wherein the meat product is selected from chicken, beef, pork, lamb, bison, alligator, fish, shell fish, mollusks and mixtures thereof.
